(19) United States
(12) Patent Application Publication
(10) Pub. No.: US 2026/0246582 A1
(43) Pub. Date: Aug. 20, 2026

(54) METHODS AND APPARATUSES FOR ENHANCED DMRS

(71) Applicant: LENOVO (BEIJING) LIMITED, Beijing (CN)

(72) Inventors: Yi ZHANG, Beijing (CN); Chenxi ZHU, Fairfax, VA (US); Wei LING, Beijing (CN); Bingchao LIU, Beijing (CN); Lingling XIAO, Beijing (CN)

(21) Appl. No.: 19/154,652

(22) PCT Filed: Feb. 15, 2023
(86) PCT No.: PCT/CN2023/076137

§ 371 Date: Aug. 7, 2025

(51) Int. Cl. H04L 5/00

(52) U.S. Cl. CPC H04L 5/0048; H04L 5/0026; H04L 5/0044; H04L 5/0091

(57) ABSTRACT

Embodiments of the present application relate to methods and apparatuses for enhanced demodulation reference signal (DMRS). According to an embodiment of the present disclosure, a user equipment (UE) can include: a transceiver that receives multiple MsgA physical uplink shared channel (PUSCH) resource configurations at least including an enhanced MsgA PUSCH resource configuration, wherein the enhanced MsgA PUSCH resource configuration includes an enhanced MsgA DMRS configuration; and a processor that is coupled with the transceiver and determines DMRS port(s) based on the enhanced MsgA DMRS configuration; wherein the transceiver further transmits a MsgA PUSCH transmission and a DMRS for the MsgA PUSCH transmission with a DMRS port selected from the determined DMRS port(s).

### TECHNICAL FIELD

Embodiments of the present application generally relate to wireless communication technologies, and especially to methods and apparatuses for enhanced demodulation reference signal (DMRS).

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long term evolution (LTE) systems, LTE-advanced (LTE-A) systems, or LTE-A Pro systems, and fifth generation (5G) systems which may also be referred to as new radio (NR) systems.

In a wireless communication system, a 2-step random access channel (RACH) procedure may be used by a user equipment (UE) to access a wireless network. The 2-step RACH procedure may include transmitting MsgA and receiving MsgB. MsgA may include a preamble and a payload (e.g., a physical uplink shared channel (PUSCH) transmission, which is also referred to as MsgA PUSCH or MsgA PUSCH transmission). Currently, details regarding enhanced DMRS for MsgA PUSCH need to be further discussed.

### SUMMARY OF THE APPLICATION

Embodiments of the present application at least provide technical solutions for enhanced DMRS.

According to some embodiments of the present application, a UE may include: a transceiver that receives multiple MsgA PUSCH resource configurations at least including an enhanced MsgA PUSCH resource configuration, wherein the enhanced MsgA PUSCH resource configuration includes an enhanced MsgA DMRS configuration; and a processor that is coupled with the transceiver and determines DMRS port(s) based on the enhanced MsgA DMRS configuration; wherein the transceiver further transmits a MsgA PUSCH transmission and a DMRS for the MsgA PUSCH transmission with a DMRS port selected from the determined DMRS port(s).

In some embodiments of the present application, the enhanced MsgA PUSCH resource configuration indicates a Type 1 DMRS or an enhanced Type 1 (eType1) DMRS.

In some embodiments of the present application, the enhanced MsgA DMRS configuration indicates at least one of a first DMRS port group or a second DMRS port group from which the DMRS port(s) is (are) determined.

In some embodiments of the present application, the first DMRS port group includes DMRS ports with indexes of 0 through 7 and the second DMRS port group includes DMRS ports with indexes of 8 through 15.

In some embodiments of the present application, the enhanced MsgA DMRS configuration includes a parameter indicating a number of DMRS ports in each code division multiplexing (CDM) group of each DMRS port group for determining the DMRS port(s).

In some embodiments of the present application, a value of the parameter indicates that the first DMRS port in each CDM group of each DMRS port group is used for determining the DMRS port(s).

In some embodiments of the present application, a value of the parameter indicates that the first two DMRS ports in each CDM group of each DMRS port group are used for determining the DMRS port(s).

In some embodiments of the present application, a value of the parameter indicates that four DMRS ports in each CDM group of each DMRS port group are used for determining the DMRS port(s).

In some embodiments of the present application, in the case that the enhanced MsgA DMRS configuration does not include a parameter indicating a number of DMRS ports in each CDM group of each DMRS port group for determining the DMRS port(s), the processor determines that four DMRS ports in each CDM group of each DMRS port group are used for determining the DMRS port(s).

In some embodiments of the present application, the enhanced MsgA DMRS configuration includes a parameter indicating a number of DMRS ports in each CDM group for determining the DMRS port(s), wherein a value of the parameter indicates that eight DMRS ports in each CDM group are used for determining the DMRS port(s).

In some embodiments of the present application, in the case that the enhanced MsgA DMRS configuration does not include a parameter indicating a number of DMRS ports in each CDM group for determining the DMRS port(s), the processor determines the first four DMRS ports from each CDM group indicated in the enhanced MsgA DMRS configuration based on a parameter in the enhanced MsgA DMRS configuration indicating a single-symbol DMRS or a double-symbol DMRS.

In some embodiments of the present application, the enhanced MsgA PUSCH resource configuration indicates that a number of resource blocks (RBs) or a number of interlaces in a PUSCH occasion is expected to be even.

In some embodiments of the present application, in the case that the enhanced MsgA PUSCH resource configuration is associated with an eType1 DMRS and a time-frequency resource configured by the enhanced MsgA PUSCH resource configuration overlaps with a time-frequency resource configured by another MsgA PUSCH resource configuration associated with a Type 1 DMRS, the enhanced MsgA DMRS configuration and a MsgA DMRS configuration in the another MsgA PUSCH resource configuration indicate different CDM groups for determining DMRS port(s).

According to some embodiments of the present application, a base station (BS) may include: a transceiver that transmits multiple MsgA PUSCH resource configurations at least including an enhanced MsgA PUSCH resource configuration, wherein the enhanced MsgA PUSCH resource configuration includes an enhanced MsgA DMRS configuration; and a processor that is coupled with the transceiver and determines DMRS port(s) based on the enhanced MsgA DMRS configuration; wherein the transceiver further receives a MsgA PUSCH transmission and a DMRS for the MsgA PUSCH transmission with a DMRS port within the determined DMRS port(s).

In some embodiments of the present application, the enhanced MsgA PUSCH resource configuration indicates a Type 1 DMRS or an eType1 DMRS.

In some embodiments of the present application, the enhanced MsgA DMRS configuration indicates at least one of a first DMRS port group or a second DMRS port group from which the DMRS port(s) is (are) determined.

In some embodiments of the present application, the first DMRS port group includes DMRS ports with indexes of 0 through 7 and the second DMRS port group includes DMRS ports with indexes of 8 through 15.

In some embodiments of the present application, the enhanced MsgA DMRS configuration includes a parameter indicating a number of DMRS ports in each CDM group of each DMRS port group for determining the DMRS port(s).

In some embodiments of the present application, a value of the parameter indicates that the first DMRS port in each CDM group of each DMRS port group is used for determining the DMRS port(s).

In some embodiments of the present application, a value of the parameter indicates that the first two DMRS ports in each CDM group of each DMRS port group are used for determining the DMRS port(s).

In some embodiments of the present application, a value of the parameter indicates that four DMRS ports in each CDM group of each DMRS port group are used for determining the DMRS port(s).

In some embodiments of the present application, in the case that the enhanced MsgA DMRS configuration does not include a parameter indicating a number of DMRS ports in each CDM group of each DMRS port group for determining the DMRS port(s), the processor determines that four DMRS ports in each CDM group of each DMRS port group are used for determining the DMRS port(s).

In some embodiments of the present application, the enhanced MsgA DMRS configuration includes a parameter indicating a number of DMRS ports in each CDM group for determining the DMRS port(s), wherein a value of the parameter indicates that eight DMRS ports in each CDM group are used for determining the DMRS port(s).

In some embodiments of the present application, in the case that the enhanced MsgA DMRS configuration does not include a parameter indicating a number of DMRS ports in each CDM group for determining the DMRS port(s), the processor determines the first four DMRS ports from each CDM group indicated in the enhanced MsgA DMRS configuration based on a parameter in the enhanced MsgA DMRS configuration indicating a single-symbol DMRS or a double-symbol DMRS.

In some embodiments of the present application, the enhanced MsgA PUSCH resource configuration indicates that a number of RBs or a number of interlaces in a PUSCH occasion is restricted to be even.

In some embodiments of the present application, in the case that the enhanced MsgA PUSCH resource configuration is associated with an eType1 DMRS and a time-frequency PUSCH resource configured by the enhanced MsgA PUSCH resource configuration overlaps with a time-frequency resource configured by the another MsgA PUSCH resource configuration associated with a Type 1 DMRS, the enhanced MsgA DMRS configuration and a MsgA DMRS configuration in the another MsgA PUSCH resource configuration indicate different CDM groups for determining DMRS port(s).

According to some embodiments of the present application, a method performed by a UE may include: receiving multiple MsgA PUSCH resource configurations at least including an enhanced MsgA PUSCH resource configuration, wherein the enhanced MsgA PUSCH resource configuration includes an enhanced MsgA DMRS configuration; determining DMRS port(s) based on the enhanced MsgA DMRS configuration; and transmitting a MsgA PUSCH transmission and a DMRS for the MsgA PUSCH transmission with a DMRS port selected from the determined DMRS port(s).

According to some embodiments of the present application, a method performed by a BS may include: transmitting multiple MsgA PUSCH resource configurations at least including an enhanced MsgA PUSCH resource configuration, wherein the enhanced MsgA PUSCH resource configuration includes an enhanced MsgA DMRS configuration; determining DMRS port(s) based on the enhanced MsgA DMRS configuration; and receiving a MsgA PUSCH transmission and a DMRS for the MsgA PUSCH transmission with a DMRS port within the determined DMRS port(s).

According to some embodiments of the present application, a UE may include: a transceiver that receives multiple MsgA PUSCH resource configurations, wherein all of the multiple MsgA PUSCH resource configurations are enhanced MsgA PUSCH resource configurations associated with an eType1 DMRS; and a processor that is coupled with the transceiver and stops 2-step random access procedure and switches to 4-step random access procedure.

According to some embodiments of the present application, a method performed by a UE may include: receiving multiple MsgA PUSCH resource configurations, wherein all of the multiple MsgA PUSCH resource configurations are enhanced MsgA PUSCH resource configurations associated with an eType1 DMRS; and stopping 2-step random access procedure and switching to 4-step random access procedure.

In some embodiments of the present application, the multiple MsgA PUSCH resource configurations are configured for all uplink bandwidth parts (BWPs), for an active uplink BWP, or for an initial uplink BWP.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 is a schematic diagram illustrating an exemplary wireless communication system according to some embodiments of the present application;

FIG. 2 illustrates an exemplary mapping between preambles of a physical RACH (PRACH) slot and PUSCH occasions associated with DMRS resources according to some embodiments of the present application;

FIG. 3 is a flow chart illustrating an exemplary method for enhanced DMRS according to some embodiments of the present application;

FIG. 4 is a flow chart illustrating an exemplary method for enhanced DMRS according to some other embodiments of the present application; and

FIG. 5 illustrates a simplified block diagram of an exemplary apparatus for enhanced DMRS according to some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

While operations are depicted in the drawings in a particular order, persons skilled in the art will readily recognize that such operations need not be performed in the particular order as shown or in a sequential order, or that all illustrated operations need be performed, to achieve desirable results; sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present application, examples of which are illustrated in the accompanying drawings. To facilitate understanding, embodiments are provided under specific network architecture and new service scenarios, such as 3GPP LTE and LTE advanced, 3GPP 5G NR, 5G-Advanced, 6G, and so on. It is contemplated that along with developments of network architectures and new service scenarios, all embodiments in the present application are also applicable to similar technical problems; and moreover, the terminologies recited in the present application may change, which should not affect the principle of the present application.

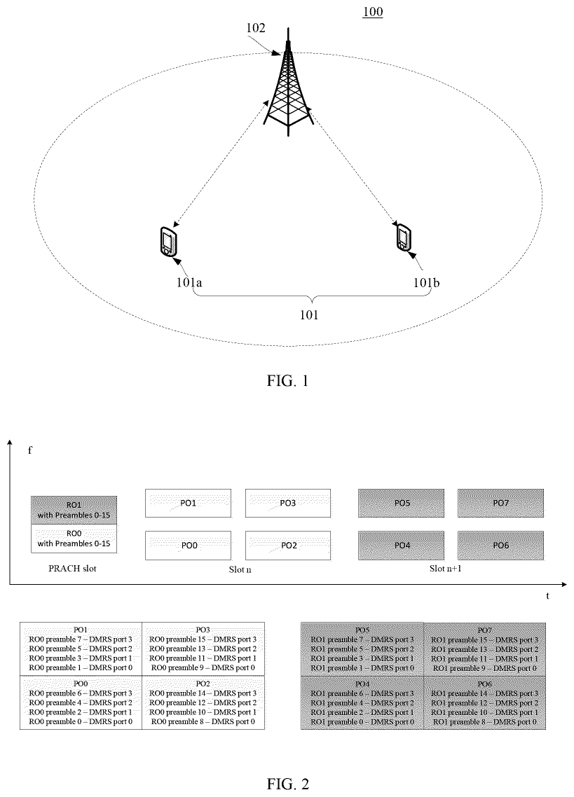

FIG. 1 illustrates an exemplary wireless communication system 100 in accordance with some embodiments of the present application.

As shown in FIG. 1, the wireless communication system 100 includes at least one UE 101 and at least one BS 102. In particular, the wireless communication system 100 includes two UEs 101 (e.g., UE 101a and UE 101b) and one BS 102 for illustrative purpose. Although a specific number of UEs 101 and BS 102 are depicted in FIG. 1, it is contemplated that any number of UEs 101 and BSs 102 may be included in the wireless communication system 100.

According to some embodiments of the present disclosure, the UE(s) 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like.

According to some other embodiments of the present disclosure, the UE(s) 101 may include a portable wireless communication device, a smart phone, a cellular telephone, a flip phone, a device having a subscriber identity module, a personal computer, a selective call receiver, or any other device that is capable of sending and receiving communication signals on a wireless network.

According to some other embodiments of the present disclosure, the UE(s) 101 may include wearable devices, such as smart watches, fitness bands, optical head-mounted displays, or the like.

According to some embodiments of the present disclosure, the UE(s) 101 may include vehicle UEs (VUEs) and/or power-saving UEs (also referred to as power sensitive UEs). The power-saving UEs may include vulnerable road users (VRUs), public safety UEs (PS-UEs), and/or commercial sidelink UEs (CS-UEs) that are sensitive to power consumption. In an embodiment of the present disclosure, a VRU may include a pedestrian UE (P-UE), a cyclist UE, a wheelchair UE or other UEs which require power saving compared with a VUE.

Moreover, the UE(s) 101 may be referred to as a subscriber unit, a mobile, a mobile station, a user, a terminal, a mobile terminal, a wireless terminal, a fixed terminal, a subscriber station, a user terminal, or a device, or described using other terminology used in the art.

Both the UE 101a and the UE 101b in the embodiments of FIG. 1 are in a coverage area of the BS 102, and may transmit information or data to the BS 102 and receive control information or data from the BS 102, for example, via LTE or NR Uu interface. In other embodiments, one or more of the UE 101a and the UE 101b may be outside of the coverage area of the BS 102. In some embodiments, the UE 101a and the UE 101b may communicate with each other via sidelink.

The BS 102 may be distributed over a geographic region. In certain embodiments of the present disclosure, the BS 102 may also be referred to as an access point, an access terminal, a base, a base unit, a macro cell, a Node-B, an evolved Node B (eNB), a generalized Node B (gNB), a Home Node-B, a relay node, or a device, or described using other terminology used in the art. The BS 102 is generally a part of a radio access network that may include one or more controllers communicably coupled to the BS 102.

The wireless communication system 100 may be compatible with any type of network that is capable of sending and receiving wireless communication signals. For example, the wireless communication system 100 is compatible with a wireless communication network, a cellular telephone network, a time division multiple access (TDMA) based network, a code division multiple access (CDMA) based network, an orthogonal frequency division multiple access (OFDMA) based network, an LTE network, a 3GPP-based network, a 3GPP 5G network, a satellite communications network, a high-altitude platform network, and/or other communications networks.

In some embodiments of the present disclosure, the wireless communication system 100 is compatible with the 5G NR of the 3GPP protocol, wherein the BS(s) 102 transmit data using an orthogonal frequency division multiplexing (OFDM) modulation scheme on the downlink (DL) and the UE(s) 101 transmit data on the uplink (UL) using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present disclosure, the BS(s) 102 may communicate using other communication protocols, such as the IEEE 802.11 family of wireless communication protocols. Further, in some embodiments of the present disclosure, the BS(s) 102 may communicate over licensed spectrums, whereas in other embodiments, the BS(s) 102 may communicate over unlicensed spectrums. The present disclosure is not intended to be limited to the implementation of any particular wireless communication system architecture or protocol. In yet some embodiments of the present disclosure, the BS(s) 102 may communicate with the UE(s) 101 using the 3GPP 5G protocols.

In NR systems, a random access procedure (also called RACH procedure) may be utilized for various purposes. For example, it may be utilized by a UE in initial access to find a cell to camp on; or it may be utilized by a UE which is in a radio resource control (RRC) idle state or RRC inactive state to switch to an RRC connected state to start data transmission or reception; or it may be utilized by a UE in an RRC connected state to re-establish the lost UL synchronization, etc.

In order to reduce signaling overhead and delay in a RACH procedure, a 2-step RACH procedure is proposed in 3GPP Release 16 (Rel-16). A 2-step RACH procedure performed by a UE may include transmitting MsgA and receiving MsgB. MsgA may include preamble (also referred to as MsgA preamble) and payload. The payload may be a PUSCH transmission, which is also referred to as MsgA PUSCH transmission.

An exemplary MsgA PUSCH configuration, i.e., MsgA-PUSCH-Config information element (IE) as specified in TS 38.331, is provided below. The MsgA-PUSCH-Config IE is used to specify a PUSCH allocation for MsgA, e.g., PUSCH resource for a MsgA PUSCH transmission. The definitions for each parameter included in the MsgA-PUSCH-Config IE may be the same as those specified in TS 38.331.

MsgA-PUSCH-Config IE

-- ASN1START
-- TAG-MSGA-PUSCH-CONFIG-START

| | |
|---|---|
| MsgA-PUSCH-Config ::= | SEQUENCE { |
| msgA-PUSCH-ResourceGroupA | MsgA-PUSCH-Resource |

OPTIONAL, -- Cond InitialBWPConfig

| | |
|---|---|
| msgA-PUSCH-ResourceGroupB | MsgA-PUSCH-Resource |

OPTIONAL, -- Cond GroupBConfigured

| | |
|---|---|
| msgA-TransformPrecoder | ENUMERATED {enabled, disabled} |

OPTIONAL, -- Need R

| | |
|---|---|
| msgA-DataScramblingIndex | INTEGER (0..1023) |

OPTIONAL, -- Need S

| | |
|---|---|
| msgA-DeltaPreamble | INTEGER (−1..6) |

OPTIONAL -- Need R
}

| | |
|---|---|
| MsgA-PUSCH-Resource ::= | SEQUENCE { |
| msgA-MCS | INTEGER (0..15), |
| nrofSlotsMsgA-PUSCH | INTEGER (1..4), |
| nrofMsgA-PO-PerSlot | ENUMERATED {one, two, three, six}, |
| msgA-PUSCH-TimeDomainOffset | INTEGER (1..32), |
| msgA-PUSCH-TimeDomainAllocation | INTEGER (1..maxNrofUL-Allocations) |

OPTIONAL, -- Need S

| | |
|---|---|
| startSymbolAndLengthMsgA-PO | INTEGER (0..127) |

OPTIONAL, -- Need S

| | |
|---|---|
| mappingTypeMsgA-PUSCH | ENUMERATED {typeA, typeB} |

OPTIONAL, -- Need S

| | |
|---|---|
| guardPeriodMsgA-PUSCH | INTEGER (0..3) |

OPTIONAL, -- Need R

| | |
|---|---|
| guardBandMsgA-PUSCH | INTEGER (0..1), |
| frequencyStartMsgA-PUSCH | INTEGER (0..maxNrofPhysicalResourceBlocks−1), |
| nrofPRBs-PerMsgA-PO | INTEGER (1..32), |
| nrofMsgA-PO-FDM | ENUMERATED {one, two, four, eight}, |
| msgA-IntraSlotFrequencyHopping | ENUMERATED {enabled} |

OPTIONAL, -- Need R

| | |
|---|---|
| msgA-HoppingBits | BIT STRING (SIZE(2)) |

OPTIONAL, -- Cond FreqHopConfigured

| | |
|---|---|
| msgA-DMRS-Config | MsgA-DMRS-Config, |
| nrofDMRS-Sequences | INTEGER (1..2), |
| msgA-Alpha | ENUMERATED {alpha0, alpha04, alpha05, alpha06, |
| | alpha07, alpha08, alpha09, alpha1} |

OPTIONAL, -- Need S

| | |
|---|---|
| interlaceIndexFirstPO-MsgA-PUSCH | INTEGER (1..10) |

OPTIONAL, -- Need R

| | |
|---|---|
| nrofInterlacesPerMsgA-PO | INTEGER (1..10) |

OPTIONAL, -- Need R
...
}

| | |
|---|---|
| MsgA-DMRS-Config ::= | SEQUENCE { |
| msgA-DMRS-AdditionalPosition | ENUMERATED {pos0, pos1, pos3} |

OPTIONAL, -- Need S

| | |
|---|---|
| msgA-MaxLength | ENUMERATED {len2} |

OPTIONAL, -- Need S

| | |
|---|---|
| msgA-PUSCH-DMRS-CDM-Group | INTEGER (0..1) |

OPTIONAL, -- Need S

| | |
|---|---|
| msgA-PUSCH-NrofPorts | INTEGER (0..1) |

OPTIONAL, -- Need S

| | |
|---|---|
| msgA-ScramblingID0 | INTEGER (0..65535) |

OPTIONAL, -- Need S

| | |
|---|---|
| msgA-ScramblingID1 | INTEGER (0..65535) |

OPTIONAL -- Need S
}

As shown above, the MsgA-PUSCH-Config IE may include a related DMRS configuration (e.g., msgA-DMRS-Config), which may include the following parameters:
msgA-MaxLength, which indicates single-symbol DMRS or double-symbol DMRS; if the field is absent, the UE applies value len1 (e.g., single-symbol DMRS);
msgA-PUSCH-DMRS-CDM-Group, which is a 1-bit indication indicating indices of CDM group(s); if the field is absent, then both CDM groups are used; and
msgA-PUSCH-NrofPorts, wherein a value of 0 indicates 1 port per CDM group, and a value of 1 indicates 2 ports per CDM group; if the field is absent, then 4 ports per CDM group are used.

The above three parameters may be used to determine DMRS port(s) associated with a PUSCH occasion. For example, the following Table 1 shows possible DMRS port configuration(s) and corresponding DMRS port index(es).

TABLE 1
DMRS port configuration(s) and corresponding DMRS port index(es)

| DMRS port | | | | | |
|---|---|---|---|---|---|
| Configuration | | | | | |
| Index (for | Total | Value of | | | |
| identifying | DMRS | msgA-PUSCH- | Value of | | DMRS |
| DMRS port | port | DMRS-CDM- | msgA-PUSCH- | Value of | port |
| configuration) | number | Group | NrofPorts | msgA-MaxLength | index(es) |
| 1 | 1 | 0 (CDM group | 0 (1 port per | 0 (single-symbol | {0} |
| | | 0) | CDM group) | DMRS) | |
| 2 | 1 | 1 (CDM group | 0 (1 port per | 0 (single-symbol | {2} |
| | | 1) | CDM group) | DMRS) | |
| 3 | 2 | 0 (CDM group | 1 (2 ports per | 0 (single-symbol | {0, 1} |
| | | 0) | CDM group) | DMRS) | |
| 4 | 2 | 1 (CDM group | 1 (2 ports per | 0 (single-symbol | {2, 3} |
| | | 1) | CDM group) | DMRS) | |
| 5 | 2 | Absent (both | 0 (1 port per | 0 (single-symbol | {0, 2} |
| | | CDM group | CDM group) | DMRS) | |
| | | used) | | | |
| 6 | 4 | 0 (CDM group | Absent (4 ports | 1 (double-symbol | {0, 1, 4, 5} |
| | | 0) | per CDM | DMRS) | |
| | | | group) | | |
| 7 | 4 | 1 (CDM group | Absent (4 ports | 1 (double-symbol | {2, 3, 6, 7} |
| | | 1) | per CDM | DMRS) | |
| | | | group) | | |
| 8 | 4 | Absent (both | 1 (2 ports per | 0 (single-symbol | {0, 1, 2, 3} |
| | | CDM group | CDM group) | DMRS) | |
| | | used) | | | |
| 9 | 8 | Absent (both | Absent (4 ports | 1 (double-symbol | {0, 1, 2, 3, 4, |
| | | CDM group | per CDM | DMRS) | 5, 6, 7} |
| | | used) | group) | | |

Referring to Table 1, the DMRS port index(es) may be determined based on msgA-PUSCH-DMRS-CDM-group, msgA-PUSCH-NrofPorts, and msgA-Maxlength. For example, for configuration index of 4, msgA-Maxlength=0 indicates single-symbol DMRS, and thus CDM group 0 may include DMRS ports {0, 1} and CDM group 1 may include DMRS ports {2, 3}. msgA-PUSCH-DMRS-CDM-group=1 indicates that CDM group 1 is used. msgA-PUSCH-NrofPorts=1 indicates 2 ports per CDM group. Based on the above parameters, DMRS ports {2, 3} included in CDM group 1 can be determined.

As specified in TS 38.213, the mapping between preambles of a PRACH slot and PUSCH occasions associated with DMRS resources may follow the following principles.

Each consecutive number of N_{preamble} preamble indexes from valid PRACH occasions in a PRACH slot
first, in increasing order of preamble indexes within a single PRACH occasion;
second, in increasing order of frequency resource indexes for frequency multiplexed PRACH occasions; and
third, in increasing order of time resource indexes for time multiplexed PRACH occasions within a PRACH slot;
   are mapped to a valid PUSCH occasion and the associated DMRS resource
first, in increasing order of frequency resource indexes f_{id} for frequency multiplexed PUSCH occasions;
second, in increasing order of DMRS resource indexes within a PUSCH occasion, where a DMRS resource index DMRS_{id} is determined first in an ascending order of a DMRS port index and second in an ascending order of a DMRS sequence index;
third, in increasing order of time resource indexes t_{id} for time multiplexed PUSCH occasions within a PUSCH slot; and
fourth, in increasing order of indexes for Nₛ PUSCH slots.

FIG. 2 illustrates an exemplary mapping between preambles of a PRACH slot and PUSCH occasions associated with DMRS resources according to some embodiments of the present application. In FIG. 2, each DMRS resource may include a different DMRS port, e.g., have a different DMRS port index.

FIG. 2 illustrates two RACH occasions (e.g., RO0 and RO1) in a PRACH slot, four PUSCH occasions (POs) in slot n (e.g., PO0, PO1, PO2, and PO3), and four POs in slot n+1 (e.g., PO4, PO5, PO6, and PO7), wherein each RO is associated with 16 preambles (e.g., preambles 0-15) and each PO is associated with four DMRS resources (e.g., DMRS ports 0-3).

Based on the mapping relationship defined in TS 38.213, a preamble in an RO may be mapped to a PO associated with a DMRS port. That is, based on the preamble transmitted in an RO, a UE may determine a corresponding PO and a corresponding DMRS port for MsgA PUSCH transmission.

For example, as shown in FIG. 2, preambles 0-15 in RO0 may be mapped to PO0, PO1, PO2, and PO3 in slot n, wherein preambles 0, 2, 4, and 6 are mapped to PO0 and DMRS ports 0-3, respectively, preambles 1, 3, 5, and 7 are mapped to PO1 and DMRS ports 0-3, respectively, preambles 8, 10, 12, and 14 are mapped to PO2 and DMRS ports 0-3, respectively, and preambles 9, 11, 13, and 14 are mapped to PO3 and DMRS ports 0-3, respectively; preambles 0-15 in RO1 may be mapped to PO4, PO5, PO6, and PO7 in slot n+1, wherein preambles 0, 2, 4, and 6 are mapped to PO4 and DMRS ports 0-3, respectively, preambles 1, 3, 5, and 7 are mapped to PO5 and DMRS ports 0-3, respectively, preambles 8, 10, 12, and 14 are mapped to PO6 and DMRS ports 0-3, respectively, and preambles 9, 11, 13, and 14 are mapped to PO7 and DMRS ports 0-3, respectively

In 3GPP Release 18 (Rel-18), it is important to identify and specify necessary enhancements for both downlink and uplink multiple input multiple output (MIMO) for facilitating the use of large antenna array, not only for frequency range 1 (FR1) (e.g., 450 MHz-6 GHz) but also for frequency range 2 (FR2) (e.g., 24.25 GHz-52.6 GHz) to fulfil the request for evolution of NR deployments. As one aspect of the enhancements, there is a need for increasing the number of orthogonal ports for DMRS, due to the increasing need for multiplexing capacity of downlink and uplink DMRS from various use cases.

In Rel-16, maximum 4 and 8 orthogonal DMRS ports are supported for single-symbol (e.g., maxLength=1) and double-symbol (e.g., maxLength=2) Type 1 DMRS, respectively, and maximum 6 or 12 orthogonal DMRS ports are supported for single-symbol (e.g., maxLength=1) and double-symbol (e.g., maxLength=2) Type 2 DMRS, respectively. For MsgA PUSCH, only Type 1 DMRS is supported and maximum 8 orthogonal DMRS ports are used.

In Rel-18, DMRS may be enhanced by doubling the maximum number of orthogonal ports for both single-symbol and double-symbol DMRS. In detail, maximum 8 and 16 orthogonal uplink DMRS ports can be supported for single-symbol and double-symbol Type 1 DMRS, respectively. The enhanced Type 1 DMRS in Rel-18 may be referred to as eType1 DMRS. When the enhanced Type 1 DMRS is applied for MsgA PUSCH, some issues need to be solved. For example, in the example illustrated in FIG. 2, a PO may be associated with four DMRS ports. However, in Rel-18, the maximum DMRS port number can be increased to 16, and then how to configure DMRS port(s) for MsgA PUSCH transmission needs to be discussed. In addition, some other issues, e.g., how to determine DMRS port for transmitting MsgA PUSCH transmission, orphan resource element (RE) issue caused by eType1 DMRS, and how to multiplex UEs with Type 1 DMRS and eType1 DMRS also need to be solved.

Given the above, embodiments of the present application propose solutions for enhanced DMRS (e.g., eType1 DMRS) for MsgA PUSCH transmission. For example, embodiments of the present application propose solutions regarding enhanced DMRS port configuration, DMRS port determination, restriction on frequency resources for Msg-A PUSCH, or multiplexing UEs with Type 1 DMRS and eType1 DMRS. More details on embodiments of the present application will be described in the following text in combination with the appended drawings.

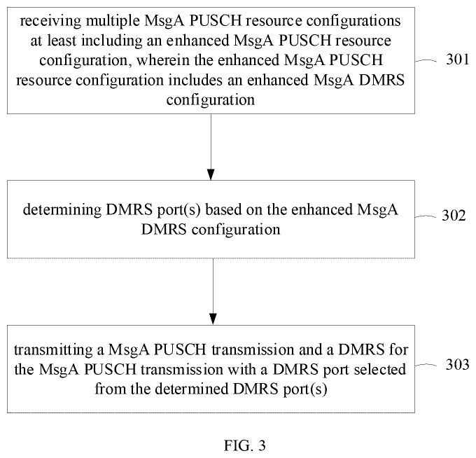

FIG. 3 is a flow chart illustrating an exemplary method for enhanced DMRS according to some embodiments of the present application. The method in FIG. 3 may be implemented by a UE (e.g., UE 101a or UE 101b as shown in FIG. 1) or any other device having similar functions.

In the exemplary method shown in FIG. 3, in operation 301, the UE may receive multiple MsgA PUSCH resource configurations from a BS (e.g., BS 102 as shown in FIG. 1). The multiple MsgA PUSCH resource configurations at least include an enhanced MsgA PUSCH resource configuration (e.g., MsgA-PUSCH-Resource-r18). The enhanced MsgA PUSCH resource configuration may include an enhanced MsgA DMRS configuration (e.g., MsgA-DMRS-Config-r18).

In some embodiments of the present application, the enhanced MsgA PUSCH resource configuration may be associated with Type 1 DMRS. In such embodiments, DMRS ports as defined in Rel-16 (e.g., DMRS ports 0-7) may be supported for MsgA PUSCH transmission. In some embodiments of the present application, the enhanced MsgA PUSCH resource configuration may be associated with eType1 DMRS. In such embodiments, more DMRS ports (e.g., DMRS ports 0-15) may be supported for MsgA PUSCH transmission.

In some examples, the enhanced MsgA PUSCH resource configuration may indicate a Type 1 DMRS or an eType1 DMRS. A Type 1 DMRS being indicated means that the enhanced MsgA PUSCH resource configuration is associated with Type 1 DMRS, and an eType1 DMRS being indicated means that the enhanced MsgA PUSCH resource configuration is associated with eType1 DMRS. As an example, the enhanced MsgA PUSCH resource configuration may explicitly indicate a Type 1 DMRS or an eType1 DMRS. In such example, the enhanced MsgA PUSCH resource configuration may include a parameter (e.g., msgA-PUSCH-DMRS-Type) to indicate a Type 1 DMRS or an eType1 DMRS. For example, the parameter may be included in the enhanced MsgA DMRS configuration or may be included in the enhanced MsgA PUSCH resource configuration but outside the enhanced MsgA DMRS configuration. As another example, the enhanced MsgA PUSCH resource configuration may implicitly indicate a Type 1 DMRS or an eType1 DMRS. In such example, when the enhanced MsgA PUSCH resource configuration does not include a parameter to indicate a Type 1 DMRS or an eType1 DMRS, the enhanced MsgA PUSCH resource configuration is associated with a default DMRS type (i.e., the default DMRS type is implicitly indicated). The default DMRS type may be a Type 1 DMRS or an eType1 DMRS.

In some embodiments, MsgA PUSCH resource configuration with a predefined index may be implicitly associated with a default DMRS type. For example, in the case that the multiple MsgA PUSCH resource configurations include two MsgA PUSCH resource configurations, the first MsgA PUSCH resource configuration (e.g., with an index of 0) may be associated with a Type 1 DMRS and the second MsgA PUSCH resource configuration (e.g., with an index of 1) may be associated with an eType1 DMRS.

In operation 302, the UE may determine DMRS port(s) based on the enhanced MsgA DMRS configuration. As stated above, when eType1 DMRS is associated with (or indicated by) the enhanced MsgA PUSCH resource configuration, the enhanced MsgA DMRS configuration may be used to support more DMRS ports and more DMRS port combinations. The following embodiments 1 and 2 provide several solutions for the enhanced MsgA DMRS configuration to support more DMRS ports and more DMRS port combinations.

### Embodiment 1

In embodiment 1, the DMRS ports may be divided into two groups, i.e., a first DMRS port group (e.g., DMRS port group 0) and a second DMRS port group (e.g., DMRS port group 1). DMRS port group 0 may include DMRS ports supported in Rel-16, e.g., DMRS ports with indexes of 0 through 7 (also referred to as DMRS ports 0-7). DMRS port group 1 may include DMRS ports other than those supported in Rel-16, e.g., DMRS ports with indexes of 8 through 15 (also referred to as DMRS ports 8-15).

In embodiment 1, three kinds of DMRS port configurations may be supported. The first kind of DMRS port configurations may be used to indicate DMRS port combinations consisting of DMRS port(s) from the first DMRS port group, the second kind of DMRS port configurations may be used to indicate DMRS port combinations consisting of DMRS port(s) from the second DMRS port group, and the third kind of DMRS port configurations may be used to indicate DMRS port combinations consisting of both DMRS port(s) from the first DMRS port group and DMRS port(s) from the second DMRS port group.

The first kind of DMRS port configurations may provide good compatibility for legacy UEs (e.g., Rel-16 UEs). The second kind of DMRS port configurations may support more enhanced MsgA PUSCH resources, wherein each enhanced MsgA PUSCH resource may identify subsets of DMRS ports. The subsets of DMRS ports may be DMRS ports from one DMRS port group, which can keep good DMRS port orthogonality between different enhanced MsgA PUSCH resources with DMRS ports from different DMRS port groups, even in case of overlapping time-frequency resources. The third kind of DMRS port configurations may support more DMRS ports and more DMRS port combinations. For example, as listed in Table 2 which will be described in detail later, DMRS port combination {0, 1, 2, . . . , 15} may be indicated to support a 16-port DMRS configuration; DMRS port combination {0, 1, 8, 9} or {2, 3, 10, 11} may be indicated to support a 4-port DMRS configuration with single-symbol DMRS and 1 CDM group; DMRS port combination {0, 1, 4, 5, 8, 9, 12, 13} or {2, 3, 6, 7, 10, 11, 14, 15} may be indicated to support a 8-port DMRS configuration with double-symbol DMRS and 1 CDM group; DMRS port combination {0, 1, 2, 3, 8, 9, 10, 11} may be indicated to support a 8-port DMRS configuration with single-symbol DMRS and 2 CDM groups.

To support the above three kinds of DMRS port configurations, the enhanced MsgA DMRS configuration may indicate at least one of the first DMRS port group or the second DMRS port group from which the DMRS port(s) is (are) determined. As an example, a parameter (e.g., msgA-PUSCH-DMRS-Port-group) may be used to indicate at least one of the first DMRS port group or the second DMRS port group.

For example, if msgA-PUSCH-DMRS-Port-group is absent in the enhanced MsgA DMRS configuration, it means that the enhanced MsgA DMRS configuration indicates the first DMRS port group (i.e., the DMRS port(s) is (are) determined from the first DMRS port group). If the value of msgA-PUSCH-DMRS-Port-group in the enhanced MsgA DMRS configuration is 0, it means that the enhanced MsgA DMRS configuration indicates the second DMRS port group (i.e., the DMRS port(s) is (are) determined from the second DMRS port group). If the value of msgA-PUSCH-DMRS-Port-group in the enhanced MsgA DMRS configuration is 1, it means that the enhanced MsgA DMRS configuration indicates both the first DMRS port group and the second DMRS port group (i.e., the DMRS port(s) is (are) determined from both the first DMRS port group and the second DMRS port group). The above states or values (e.g., being 0, 1, or absent) of msgA-PUSCH-DMRS-Port-group for indicating DMRS port group(s) are only for illustrative purpose, and it is contemplated that any other states or values of msgA-PUSCH-DMRS-Port-group may also be used for indicating DMRS port group(s).

To support the above three kinds of DMRS port configurations, a parameter (e.g., msgA-PUSCH-NrofPorts) may also be used for indicating a number of DMRS ports in each CDM group of each DMRS port group for determining the DMRS port(s).

In some embodiments, the enhanced MsgA DMRS configuration may include the parameter indicating a number of DMRS ports in each CDM group of each DMRS port group for determining the DMRS port(s). As an example, a value (e.g., 0) of the parameter may indicate that one DMRS port (e.g., the first DMRS port) in each CDM group of each DMRS port group is used for determining the DMRS port(s). As another example, a value (e.g., 1) of the parameter may indicate that two DMRS ports (e.g., the first two DMRS ports) in each CDM group of each DMRS port group are used for determining the DMRS port(s). As yet another example, a value (e.g., 2) of the parameter may indicate that four DMRS ports in each CDM group of each DMRS port group are used for determining the DMRS port(s). Alternatively, when the enhanced MsgA DMRS configuration does not include the parameter indicating a number of DMRS ports in each CDM group of each DMRS port group for determining the DMRS port(s), it means that the enhanced MsgA DMRS configuration indicates that four DMRS ports in each CDM group of each DMRS port group are used for determining the DMRS port(s).

In addition to the aforementioned parameters, the enhanced MsgA DMRS configuration may also include the parameters such as msgA-MaxLength and msgA-PUSCH-DMRS-CDM-Group, which have the same definitions as those defined in Rel-16.

The following Table 2 shows exemplary DMRS port configuration(s) and corresponding DMRS port index(es).

In the examples of Table 2, DMRS port group 0 includes DMRS ports 0-7, and may be associated with two CDM groups (e.g., CDM group 0 and CDM group 1). When single-symbol DMRS is indicated, CDM group 0 of DMRS port group 0 includes DMRS ports {0, 1}, and CDM group 1 of DMRS port group 0 includes DMRS ports {2, 3}. When double-symbol DMRS is indicated, CDM group 0 of DMRS port group 0 includes DMRS ports {0, 1, 4, 5}, and CDM group 1 of DMRS port group 0 includes DMRS ports {2, 3, 6, 7}.

Similarly, DMRS port group 1 includes DMRS ports 8-15, and may be associated with two CDM groups (e.g., CDM group 0 and CDM group 1). When single-symbol DMRS is indicated, CDM group 0 of DMRS port group 1 includes DMRS ports {8, 9}, and CDM group 1 of DMRS port group 1 includes DMRS ports {10, 11}. When double-symbol DMRS is indicated, CDM group 0 of DMRS port group 1 includes DMRS ports {8, 9, 12, 13}, and CDM group 1 of DMRS port group 1 includes DMRS ports {10, 11, 14, 15}.

In the examples of Table 2, the enhanced MsgA DMRS configuration may optionally include the following parameters:
msgA-PUSCH-DMRS-CDM-Group, which indicates CDM group(s) for determining DMRS port(s): as shown in Table 2, value 0 indicates CDM group 0, value 1 indicates CDM group 1, and being absent indicates both CDM group 0 and CDM group 1;
msgA-PUSCH-NrofPorts, which indicates the number of DMRS ports (e.g., X ports) per CDM group and per DMRS port group for determining DMRS port(s), wherein X ports per CDM group and per DMRS port group may refer to X DMRS ports in each CDM group of each DMRS port group for determining DMRS port(s): as shown in Table 2, value 0 indicates that 1 DMRS port (e.g., the first DMRS port) in each CDM group of each DMRS port group is used for determining the DMRS port(s), value 1 indicates that 2 DMRS ports (e.g., the first two DMRS ports) in each CDM group of each DMRS port group are used for determining the DMRS port(s), and being absent indicates that 4 DMRS ports in each CDM group of each DMRS port group are used for determining the DMRS port(s);
msgA-MaxLength, which indicates the number of OFDM symbols of DMRS: as shown in Table 2, value 0 indicates single-symbol DMRS, and value 1 indicates double-symbol DMRS; if the field is absent, the UE applies single-symbol DMRS; and
msgA-PUSCH-DMRS-Port-group, which indicates DMRS port group(s) for determining DMRS port(s): as shown in Table 2, being absent indicates DMRS port group 0, value 0 indicates DMRS port group 1, and value 1 indicates both DMRS port group 0 and DMRS port group 1.

TABLE 2
DMRS port configuration(s) and corresponding DMRS port index(es)

| | | | | | Value of | |
|---|---|---|---|---|---|---|
| | | | | | msgA- | |
| | Total | Value of | Value of | | PUSCH- | |
| DMRS Port | DMRS | msgA-PUSCH- | msgA- | Value of | DMRS- | DMRS |
| Configuration | port | DMRS-CDM- | PUSCH- | msgA- | Port- | port |
| Index | number | Group | NrofPorts | MaxLength | group | index(es) |
| 1 | 1 | 0 (CDM group | 0 (1 port | 0 (single- | Absent | {0} |
| | | 0) | per CDM | symbol | (DMRS | |
| | | | group and | DMRS) | port | |
| | | | per DMRS | | group | |
| | | | port | | 0) | |
| | | | group) | | | |
| 2 | 1 | 1 (CDM group | 0 (1 port | 0 (single- | Absent | {2} |
| | | 1) | per CDM | symbol | (DMRS | |
| | | | group and | DMRS) | port | |
| | | | per DMRS | | group | |
| | | | port | | 0) | |
| | | | group) | | | |
| 3 | 2 | 0 (CDM group | 1 (2 ports | 0 (single- | Absent | {0, 1} |
| | | 0) | per CDM | symbol | (DMRS | |
| | | | group and | DMRS) | port | |
| | | | per DMRS | | group | |
| | | | port | | 0) | |
| | | | group) | | | |
| 4 | 2 | 1 (CDM group | 1 (2 ports | 0 (single- | Absent | {2, 3} |
| | | 1) | per CDM | symbol | (DMRS | |
| | | | group and | DMRS) | port | |
| | | | per DMRS | | group | |
| | | | port | | 0) | |
| | | | group) | | | |
| 5 | 2 | Absent (both | 0 (1 port | 0 (single- | Absent | {0, 2} |
| | | CDM group | per CDM | symbol | (DMRS | |
| | | used) | group and | DMRS) | port | |
| | | | per DMRS | | group | |
| | | | port | | 0) | |
| | | | group) | | | |
| 6 | 4 | 0 (CDM group | Absent (4 | 1 (double- | Absent | {0, 1, 4, |
| | | 0) | ports per | symbol | (DMRS | 5} |
| | | | CDM | DMRS) | port | |
| | | | group and | | group | |
| | | | per DMRS | | 0) | |
| | | | port | | | |
| | | | group) | | | |
| 7 | 4 | 1 (CDM group | Absent (4 | 1 (double- | Absent | {2, 3, 6, |
| | | 1) | ports per | symbol | (DMRS | 7} |
| | | | CDM | DMRS) | port | |
| | | | group and | | group | |
| | | | per DMRS | | 0) | |
| | | | port | | | |
| | | | group) | | | |
| 8 | 4 | Absent (both | 1 (2 ports | 0 (single- | Absent | {0, 1, 2, |
| | | CDM group | per CDM | symbol | (DMRS | 3} |
| | | used) | group and | DMRS) | port | |
| | | | per DMRS | | group | |
| | | | port | | 0) | |
| | | | group) | | | |
| 9 | 8 | Absent (both | Absent (4 | 1 (double- | Absent | {0, 1, 2, |
| | | CDM group | ports per | symbol | (DMRS | 3, 4, 5, 6, |
| | | used) | CDM | DMRS) | port | 7} |
| | | | group and | | group | |
| | | | per DMRS | | 0) | |
| | | | port | | | |
| | | | group) | | | |
| 10 | 1 | 0 (CDM group | 0 (1 port | 0 (single- | 0 | {8} |
| | | 0) | per CDM | symbol | (DMRS | |
| | | | group and | DMRS) | port | |
| | | | per DMRS | | group | |
| | | | port | | 1) | |
| | | | group) | | | |
| 11 | 1 | 1 (CDM group | 0 (1 port | 0 (single- | 0 | {10} |
| | | 1) | per CDM | symbol | (DMRS | |
| | | | group and | DMRS) | port | |
| | | | per DMRS | | group | |
| | | | port | | 1) | |
| | | | group) | | | |
| 12 | 2 | 0 (CDM group | 1 (2 ports | 0 (single- | 0 | {8, 9} |
| | | 0) | per CDM | symbol | (DMRS | |
| | | | group and | DMRS) | port | |
| | | | per DMRS | | group | |
| | | | port | | 1) | |
| | | | group) | | | |
| 13 | 2 | 1 (CDM group | 1 (2 ports | 0 (single- | 0 | {10, 11} |
| | | 1) | per CDM | symbol | (DMRS | |
| | | | group and | DMRS) | port | |
| | | | per DMRS | | group | |
| | | | port | | 1) | |
| | | | group) | | | |
| 14 | 2 | Absent (both | 0 (1 port | 0 (single- | 0 | {8, 10} |
| | | CDM group | per CDM | symbol | (DMRS | |
| | | used) | group and | DMRS) | port | |
| | | | per DMRS | | group | |
| | | | port | | 1) | |
| | | | group) | | | |
| 15 | 4 | 0 (CDM group | Absent (4 | 1 (double- | 0 | {8, 9, 12, |
| | | 0) | ports per | symbol | (DMRS | 13} |
| | | | CDM | DMRS) | port | |
| | | | group and | | group | |
| | | | per DMRS | | 1) | |
| | | | port | | | |
| | | | group) | | | |
| 16 | 4 | 1 (CDM group | Absent (4 | 1 (double- | 0 | {10, 11, |
| | | 1) | ports per | symbol | (DMRS | 14, 15} |
| | | | CDM | DMRS) | port | |
| | | | group and | | group | |
| | | | per DMRS | | 1) | |
| | | | port | | | |
| | | | group) | | | |
| 17 | 4 | Absent (both | 1 (2 ports | 0 (single- | 0 | {8, 9, 10, |
| | | CDM group | per CDM | symbol | (DMRS | 11} |
| | | used) | group and | DMRS) | port | |
| | | | per DMRS | | group | |
| | | | port | | 1) | |
| | | | group) | | | |
| 18 | 8 | Absent (both | Absent (4 | 1 (double- | 0 | {8, 9, 10, |
| | | CDM group | ports per | symbol | (DMRS | 11, 12, |
| | | used) | CDM | DMRS) | port | 13, 14, |
| | | | group and | | group | 15} |
| | | | per DMRS | | 1) | |
| | | | port | | | |
| | | | group) | | | |
| 19 | 2 | 0 (CDM group | 0 (1 port | 0 (single- | 1 | {0, 8} |
| | | 0) | per CDM | symbol | (DMRS | |
| | | | group and | DMRS) | port | |
| | | | per DMRS | | groups | |
| | | | port | | 0 and 1) | |
| | | | group) | | | |
| 20 | 2 | 1 (CDM group | 0 (1 port | 0 (single- | 1 | {2, 10} |
| | | 1) | per CDM | symbol | (DMRS | |
| | | | group and | DMRS) | port | |
| | | | per DMRS | | groups | |
| | | | port | | 0 and 1) | |
| | | | group) | | | |
| 21 | 4 | Absent (both | 0 (1 port | 0 (single- | 1 | {0, 2, 8, |
| | | CDM group | per CDM | symbol | (DMRS | 10} |
| | | used) | group and | DMRS) | port | |
| | | | per DMRS | | groups | |
| | | | port | | 0 and 1) | |
| | | | group) | | | |
| 22 | 4 | 0 (CDM group | 1 (2 ports | 0 (single- | 1 | {0, 1, 8, |
| | | 0) | per CDM | symbol | (DMRS | 9} |
| | | | group and | DMRS) | port | |
| | | | per DMRS | | groups | |
| | | | port | | 0 and 1) | |
| | | | group) | | | |
| 23 | 4 | 1 (CDM group | 1 (2 ports | 0 (single- | 1 | {2, 3, 10, |
| | | 1) | per CDM | symbol | (DMRS | 11} |
| | | | group and | DMRS) | port | |
| | | | per DMRS | | groups | |
| | | | port | | 0 and 1) | |
| | | | group) | | | |
| 24 | 8 | 0 (CDM group | Absent (4 | 1 (double- | 1 | {0, 1, 4, |
| | | 0) | ports per | symbol | (DMRS | 5, 8, 9, |
| | | | CDM | DMRS) | port | 12, 13} |
| | | | group and | | groups | |
| | | | per DMRS | | 0 and 1) | |
| | | | port | | | |
| | | | group) | | | |
| 25 | 8 | 1 (CDM group | Absent (4 | 1 (double- | 1 | (2, 3, 6, |
| | | 1) | ports per | symbol | (DMRS | 7, 10, 11, |
| | | | CDM | DMRS) | port | 14, 15} |
| | | | group and | | groups | |
| | | | per DMRS | | 0 and 1) | |
| | | | port | | | |
| | | | group) | | | |
| 26 | 8 | Absent (both | 1 (2 ports | 0 (single- | 1 | {0, 1, 2, |
| | | CDM group | per CDM | symbol | (DMRS | 3, 8, 9, |
| | | used) | group and | DMRS) | port | 10, 11} |
| | | | per DMRS | | groups | |
| | | | port | | 0 and 1) | |
| | | | group) | | | |
| 27 | 16 | Absent (both | Absent (4 | 1 (double- | 1 | {0, 1, 2, |
| | | CDM group | ports per | symbol | (DMRS | 3, 4, 5, 6, |
| | | used) | CDM | DMRS) | port | 7, 8, 9, |
| | | | group and | | groups | 10, 11, |
| | | | per DMRS | | 0 and 1) | 12, 13, |
| | | | port | | | 14, 15} |
| | | | group) | | | |

The DMRS port configurations in Table 2 may include three kinds of DMRS port configurations as described above. For example, DMRS port configurations with indexes of 0-9 are the first kind of DMRS port configurations, which indicate DMRS combinations consisting of DMRS port(s) from DMRS port group 0 and are the same as those in Table 1. DMRS port configurations with indexes of 10-18 are the second kind of DMRS port configurations, which indicate DMRS combinations consisting of DMRS port(s) from DMRS port group 1. DMRS port configurations with indexes of 19-27 are the third kind of DMRS port configurations, which indicate DMRS combinations consisting of both DMRS port(s) from DMRS port group 0 and DMRS port(s) from DMRS port group 1.

Based on the parameters such as msgA-PUSCH-DMRS-CDM-Group, msgA-PUSCH-NrofPorts, msgA-MaxLength, and msgA-PUSCH-DMRS-Port-group, the UE may determine DMRS port index(es).

As an example, based on msgA-PUSCH-DMRS-CDM-Group=0, msgA-PUSCH-NrofPorts=0, msgA-MaxLength=0, and msgA-PUSCH-DMRS-Port-group=0 (i.e., DMRS port configuration with an index of 10 in Table 2), the UE may determine the first port in the indicated CDM group 0 (which includes DMRS ports {8, 9}) of the indicated DMRS port group 1, which is DMRS port 8.

As another example, based on msgA-PUSCH-DMRS-CDM-Group being absent, msgA-PUSCH-NrofPorts=1, msgA-MaxLength=0, and msgA-PUSCH-DMRS-Port-group=1 (i.e., DMRS port configuration with an index of 26 in Table 2), the UE may determine the first two ports in each indicated CDM group of each indicated DMRS port, i.e., the first two ports in CDM group 0 (e.g., DMRS ports {0, 1}) of DMRS port group 0, the first two ports in CDM group 1 (e.g., DMRS ports {2, 3}) of DMRS port group 0, the first two ports in CDM group 0 (e.g., DMRS ports {8, 9}) of DMRS port group 1, and the first two ports in CDM group 1 (e.g., DMRS ports {10, 11}) of DMRS port group 1, which are DMRS ports {0, 1, 2, 3, 8, 9, 10, 11}.

As another example, based on msgA-PUSCH-DMRS-CDM-Group being absent, msgA-PUSCH-NrofPorts being absent, msgA-MaxLength=0, and msgA-PUSCH-DMRS-Port-group=1 (i.e., DMRS port configuration with an index of 27 in Table 2), the UE may determine four ports in each indicated CDM group of each indicated DMRS port, i.e., the four ports in CDM group 0 (e.g., DMRS ports {0, 1, 4, 5}) of DMRS port group 0, the four ports in CDM group 1 (e.g., DMRS ports {2, 3, 6, 7}) of DMRS port group 0, the four ports in CDM group 0 (e.g., DMRS ports {8, 9, 12, 13}) of DMRS port group 1, and the four ports in CDM group 1 (e.g., DMRS ports {10, 11, 14, 15}) of DMRS port group 1, which are DMRS ports {0, 1, 2, 3, 4, 5, 6, 7, 8, 9, 10, 11, 12, 13, 14, 15}.

The DMRS port configurations in Table 2 consider the compatibility for MsgA DMRS configurations in Rel-16. Accordingly, msgA-PUSCH-DMRS-CDM-Group, msgA-PUSCH-NrofPorts, and msgA-MaxLength in Table 2 may reuse the states or values (e.g., being absent, being 0, or being 1) and meanings of msgA-PUSCH-DMRS-CDM-Group, msgA-PUSCH-NrofPorts, and msgA-MaxLength in Rel-16, respectively.

In some other embodiments of the present application, the compatibility for MsgA DMRS configurations in Rel-16 may be not considered, and the states (or values) and meanings of msgA-PUSCH-NrofPorts may change. For example, msgA-PUSCH-NrofPorts included in the enhanced MsgA DMRS configuration may include four states (or values), e.g., value 0 indicating 1 port per CDM group, value 1 indicating 2 ports per CDM group, value 2 indicating 4 ports per CDM group, and being absent indicating 8 ports per CDM group.

In some other embodiments of the present application, the states (or values) and meanings of msgA-PUSCH-DMRS-port-group may change. For example, msgA-PUSCH-DMRS-port-group included in the enhanced MsgA DMRS configuration may include 3 states (or values), e.g., value 0 indicating DMRS port(s) from DMRS port group 0, value 1 indicating DMRS port(s) from DMRS port group 1, and being absent indicating DMRS port(s) from both DMRS port group 0 and DMRS port group 1.

The DMRS port configurations in Table 2 are only for illustrative purpose. It is contemplated that any other DMRS port configurations not shown in Table 2 or part of DMRS port configurations in Table 2 may be supported for MsgA PUSCH transmission.

More DMRS port combinations in embodiment 1 may increase the flexibility for UE multiplexing. However, it may increase the complexity for signalling design and BS's realization for determining the best DMRS configuration. Given this, the following embodiment 2 provides a simplified scheme for DMRS port configurations.

### Embodiment 2

In embodiment 2, a CDM group may include 4 DMRS ports for single-symbol DMRS and include 8 DMRS ports for double-symbol DMRS. The enhanced MsgA DMRS configuration may include a parameter indicating a number of DMRS ports in each CDM group for determining the DMRS port(s).

In some examples, the aforementioned parameter may reuse the parameter msgA-PUSCH-NrofPorts in Rel-16. However, in Rel-16, msgA-PUSCH-NrofPorts may indicate at most 4 DMRS ports per CDM group, whereas for eType1 DMRS, a CDM group may include 8 DMRS ports for double-symbol DMRS. Given this, the aforementioned parameter needs to have value(s) to indicate more than 4 DMRS ports (e.g., 8 DMRS ports) in each CDM group. That is, in addition to the three states (or values) of msgA-PUSCH-NrofPorts in Rel-16, an addition state (or value) may be added to indicate that 8 DMRS ports in each CDM group are used for determining the DMRS port(s).

In addition, in Rel-16, when msgA-PUSCH-DMRS-CDM-Group is configured as absent (i.e., both CDM groups are used), msgA-PUSCH-NrofPorts is configured as absent (i.e., 4 ports per CDM group), and msgA-MaxLength is configured as 1 (i.e., double-symbol DMRS), the MsgA DMRS configuration may indicate 4 DMRS ports in each CDM group. However, if such configuration is reused for eType1 DMRS, there may be ambiguity since 8 DMRS ports are included in one CDM group for double-symbol DMRS and which 4 DMRS ports from the 8 DMRS ports is indicated by msgA-PUSCH-NrofPorts being absent is not clear. Given this, to ensure the compatibility with DMRS port configurations in Rel-16 as well as indicate DMRS ports for eType1 DMRS, the meaning of msgA-PUSCH-NrofPorts being absent may change. For example, in the case that the enhanced MsgA DMRS configuration does not include the parameter (e.g., msgA-PUSCH-NrofPorts) indicating a number of DMRS ports in each CDM group for determining the DMRS port(s), it means that the enhanced MsgA DMRS configuration indicates the first four DMRS ports from each CDM group indicated in the enhanced MsgA DMRS configuration based on a parameter (e.g., msgA-MaxLength) in the enhanced MsgA DMRS configuration indicating a single-symbol DMRS or a double-symbol DMRS.

As an example, the following changes (contents marked with strikethrough represent deletions and underlined contents represent additions) may be made to the description related to msgA-PUSCH-NrofPorts in 3GPP standard documents. After such changes, msgA-PUSCH-NrofPorts may be used for DMRS port determination for both Type 1 and eType1 DMRS with single-symbol DMRS and double-symbol DMRS configurations.
For MsgA PUSCH transmission, if the UE is not configured with msgA-PUSCH-NrofPorts, the UE shall assume that the first 4 ports from candidate ports determined by msgA-PUSCH-DMRS-CDM-Group and msgA-MaxLength are configured per DM-RS CDM group (or for single and double symbol DM-RS). Otherwise, msgA-PUSCH-NrofPorts with a value of 0 indicates the first port per DM-RS CDM group, a value of 1 indicates the first two ports per DM-RS CDM group, and a value of 2 indicates eight ports per DM-RS CDM group.

In addition the aforementioned parameter, the enhanced MsgA DMRS configuration may also include the parameters such as msgA-MaxLength and msgA-PUSCH-DMRS-CDM-Group, which have the same definitions as those defined in Rel-16.

The following Table 3 shows exemplary DMRS port configuration(s) and corresponding DMRS port index(es).

In the examples of Table 3, when single-symbol DMRS is indicated, CDM group 0 includes DMRS ports {0, 1, 8, 9}, and CDM group 1 includes DMRS ports {2, 3, 10, 11}. When double-symbol DMRS is indicated, CDM group 0 includes DMRS ports {0, 1, 4, 5, 8, 9, 12, 13}, and CDM group 1 includes DMRS ports {2, 3, 6, 7, 10, 11, 14, 15}.

In the examples of Table 3, the enhanced MsgA DMRS configuration may optionally include the following parameters:
msgA-PUSCH-DMRS-CDM-Group, which indicates CDM group(s) for determining DMRS port(s): as shown in Table 3, value 0 indicates CDM group 0, value 1 indicates CDM group 1, and being absent indicates both CDM group 0 and CDM group 1;
msgA-PUSCH-NrofPorts, which indicates the number of DMRS ports (e.g., X ports) per CDM group for determining DMRS port(s), wherein X ports per CDM group may refer to X DMRS ports in each CDM group for determining DMRS port(s): as shown in Table 3, value 0 indicates that 1 DMRS port (e.g., the first DMRS port) in each CDM group is used for determining the DMRS port(s), value 1 indicates that 2 DMRS ports (e.g., the first two DMRS ports) in each CDM group are used for determining the DMRS port(s), value 2 indicates that 8 DMRS port in each CDM group is used for determining the DMRS port(s), and being absent indicates that 4 DMRS ports (e.g., the first four DMRS ports) in each CDM group are used for determining the DMRS port(s); and
msgA-MaxLength, which indicates the number of OFDM symbols of DMRS: as shown in Table 3, value 0 indicates single-symbol DMRS, and value 1 indicates double-symbol DMRS, and if the field is absent, the UE applies single-symbol DMRS.

TABLE 3
DMRS port configuration(s) and corresponding DMRS port index(es)

| | Total | Value of | | | |
|---|---|---|---|---|---|
| DMRS Port | DMRS | msgA-PUSCH- | Value of | | DMRS |
| Configuration | port | DMRS-CDM- | msgA-PUSCH- | Value of | port |
| Index | number | Group | NrofPorts | msgA-MaxLength | index(es) |
| 1 | 1 | 0 (CDM group | 0 (1 port per | 0 (single-symbol | {0} |
| | | 0) | CDM group) | DMRS) | |
| 2 | 1 | 1 (CDM group | 0 (1 port per | 0 (single-symbol | {2} |
| | | 1) | CDM group) | DMRS) | |
| 3 | 2 | 0 (CDM group | 1 (2 ports per | 0 (single-symbol | {0, 1} |
| | | 0) | CDM group) | DMRS) | |
| 4 | 2 | 1 (CDM group | 1 (2 ports per | 0 (single-symbol | {2, 3} |
| | | 1) | CDM group) | DMRS) | |
| 5 | 2 | Absent (both | 0 (1 port per | 0 (single-symbol | {0, 2} |
| | | CDM group | CDM group) | DMRS) | |
| | | used) | | | |
| 6 | 4 | 0 (CDM group | Absent (4 ports | 1 (double-symbol | {0, 1, 4, |
| | | 0) | per CDM | DMRS) | 5} |
| | | | group) | | |
| 7 | 4 | 1 (CDM group | Absent (4 ports | 1 (double-symbol | {2, 3, 6, |
| | | 1) | per CDM | DMRS) | 7} |
| | | | group) | | |
| 8 | 4 | Absent (both | 1 (2 ports per | 0 (single-symbol | {0, 1, 2, |
| | | CDM group | CDM group) | DMRS) | 3} |
| | | used) | | | |
| 9 | 8 | Absent (both | Absent (4 ports | 1 (double-symbol | {0, 1, 2, |
| | | CDM group | per CDM | DMRS) | 3, 4, 5, 6, |
| | | used) | group) | | 7} |
| 10 | 4 | 0 (CDM group | Absent (4 ports | 0 (single-symbol | {0, 1, 8, |
| | | 0) | per CDM | DMRS) | 9} |
| | | | group) | | |
| 11 | 4 | 1 (CDM group | Absent (4 ports | 0 (single-symbol | {2, 3, 10, |
| | | 1) | per CDM | DMRS) | 11} |
| | | | group) | | |
| 12 | 8 | 0 (CDM group | 2 (8 ports per | 1 (double-symbol | {0, 1, 4, |
| | | 0) | CDM group) | DMRS) | 5, 8, 9, |
| | | | | | 12, 13} |
| 13 | 8 | 1 (CDM group | 2 (8 ports per | 1 (double-symbol | {2, 3, 6, |
| | | 1) | CDM group) | DMRS) | 7, 10, 11, |
| | | | | | 14, 15} |
| 14 | 8 | Absent (both | Absent (4 ports | 0 (single-symbol | {0, 1, 2, |
| | | CDM group | per CDM | DMRS) | 3, 8, 9, |
| | | used) | group) | | 10, 11} |
| 15 | 16 | Absent (both | 2 (8 ports per | 1 (double-symbol | {0, 1, 2, |
| | | CDM group | CDM group) | DMRS) | 3, 4, 5, 6, |
| | | used) | | | 7, 8, 9, |
| | | | | | 10, 11, |
| | | | | | 12, 13, |
| | | | | | 14, 15} |

In Table 3, DMRS port configurations with indexes of 0-9 are the same as those in Table 1. DMRS port configurations with indexes of 10-15 are additional DMRS port configurations. Such design can support 4-port DMRS configurations with single-symbol DMRS and 1 CDM group for achieving lower DMRS overhead (e.g., relative to legacy DMRS configurations with double-symbol DMRS and 1 CDM group in Rel-16). Moreover, it can support 8-port DMRS configurations with single-symbol DMRS and 2 CDM groups and 8-port DMRS configurations with double-symbol DMRS and 1 CDM group for achieving lower DMRS overhead (e.g., relative to legacy DMRS configurations with double-symbol DMRS and 2 CDM groups). Moreover, it can also support a 16-port DMRS configuration for achieving larger multiplexing efficiency.

Based on the parameters such as msgA-PUSCH-DMRS-CDM-Group, msgA-PUSCH-NrofPorts, and msgA-MaxLength, the UE may determine DMRS port index(es).

As an example, based on msgA-PUSCH-DMRS-CDM-Group being absent, msgA-PUSCH-NrofPorts being absent, and msgA-MaxLength=0 (i.e., DMRS port configuration with an index of 14 in Table 3), the UE may determine the first four ports in each indicated CDM group, i.e., the first four ports in CDM group 0 (e.g., DMRS ports {0, 1, 8, 9}) and the first four ports in CDM group 1 (e.g., DMRS ports {2, 3, 10, 11}), which are DMRS ports {0, 1, 2, 3, 8, 9, 10, 11}.

As another example, based on msgA-PUSCH-DMRS-CDM-Group being absent, msgA-PUSCH-NrofPorts=2, and msgA-MaxLength=1 (i.e., DMRS port configuration with an index of 15 in Table 3), the UE may determine eight ports in each indicated CDM group, i.e., the eight DMRS ports in CDM group 0 (e.g., DMRS ports {0, 1, 4, 5, 8, 9, 12, 13}) and the eight DMRS ports in CDM group 1 (e.g., DMRS ports {2, 3, 6, 7, 10, 11, 14, 15}), which are DMRS ports {0, 1, 2, 3, 4, 5, 6, 7, 8, 9, 10, 11, 12, 13, 14, 15}.

As shown in FIG. 3, after determining DMRS port(s), in operation 303, the UE may transmit a MsgA PUSCH transmission and a DMRS for the MsgA PUSCH transmission with a DMRS port selected from the determined DMRS port(s). For example, the UE may select a MsgA preamble from a group of preambles associated with the determined DMRS port(s) and transmit the preamble in a PRACH occasion (RO). The MsgA preamble in the RO may be associated with a PO and a DMRS port within the determined DMRS port(s). Then, the UE may transmit a MsgA PUSCH transmission and a DMRS for the MsgA PUSCH transmission in the PO with the DMRS port associated with the MsgA preamble in the RO.

For eType1 DMRS with length 4 frequency domain orthogonal cover code (FD-OCC) for physical downlink shared channel (PDSCH), the UE's capability information regarding whether a UE can be scheduled without a scheduling restriction may be reported to a BS. If a capability for scheduling without a scheduling restriction is not supported by the UE, the UE may expect the BS to apply a scheduling restriction to solve the orphan RE issue caused by length 4 FD-OCC, where the number of consecutively PRBs scheduled for PDSCH is even.

For MsgA PUSCH transmission, a PUSCH occasion may include a number of RBs or a number of interlaces. For example, the number of RBs included in a PUSCH occasion may be indicated by a parameter (e.g., nrofPRBs-perMsgA-PO as specified in 3GPP standard documents) included in a MsgA PUSCH resource configuration, and the number of interlaces included in a PUSCH occasion may be indicated by a parameter (e.g., nrofInterlacesPerMsgA-PO as specified in 3GPP standard documents) included in a MsgA PUSCH resource configuration. The parameter indicating the number of RBs or indicating the number of interlaces may be common for all UEs in a cell.

According to some embodiments of the present application, to reduce the BS's additional realization complexity for solving the orphan RE issue and possible MsgA PUSCH performance loss and latency, when an enhanced MsgA PUSCH resource configuration is associated with eType1 DMRS, the enhanced MsgA PUSCH resource configuration may indicate that a number of RBs or a number of interlaces in a PUSCH occasion is restricted or expected to be even. For example, the possible values of the parameter (e.g., nrofPRBs-perMsgA-PO in the enhanced MsgA PUSCH resource configuration) indicating the number of RBs in a PUSCH occasion may be defined as INTEGER (2, 4, 6, . . . , 32), or the possible values of the parameter (e.g., nrofInterlacesPerMsgA-PO in the enhanced MsgA PUSCH resource configuration) indicating the number of interlaces in a PUSCH occasion may be defined as INTEGER (2, 4, 6, . . . , 10).

According to some embodiments of the present application, for MsgA PUSCH transmission, PUSCH occasions and associated DMRS resources are shared by multiple UEs in a cell. A MsgA PUSCH configuration (e.g., MsgA-PUSCH-Config) including multiple MsgA PUSCH resource configurations may be configured per cell and per BWP (e.g., included in a BWP-UplinkCommon as specified in 3GPP standard documents).

In a cell, legacy UEs (e.g., Rel-16 or Rel-17 UEs) can only support Type 1 DMRS. That is, for a legacy UE, it can only transmit a MsgA PUSCH transmission on PUSCH sources configured by a PUSCH resource configuration in Rel-16 (e.g., MsgA-PUSCH-Resource-r16) or an enhanced MsgA PUSCH resource configuration associated with a Type 1 DMRS (e.g., MsgA-PUSCH-Resource-r18 which implicitly indicates a Type 1 DMRS). However, Rel-18 UEs and UEs beyond Rel-18 can support both Type 1 DMRS and eType1 DMRS. For example, Type 1 DMRS may be used for a channel with larger frequency selectivity whereas eType1 DMRS may be used for a channel with smaller frequency selectivity. That is, for a Rel-18 UE or a UE beyond Rel-18, it can transmit a MsgA PUSCH transmission on PUSCH sources configured by a MsgA PUSCH resource configuration in Rel-16 (e.g., MsgA-PUSCH-Resource-r16) or an enhanced MsgA PUSCH resource configuration (e.g., MsgA-PUSCH-Resource-r18) associated with a Type 1 DMRS or eType1 DMRS.

In some embodiments, to support MsgA PUSCH transmissions for multiple UEs with different DMRS types, the multiple PUSCH resource configurations configured by the BS may at least include a MsgA PUSCH resource configuration in Rel-16 (e.g., MsgA-PUSCH-Resource-r16) or an enhanced MsgA PUSCH resource configuration associated with a Type 1 DMRS (e.g., MsgA-PUSCH-Resource-r18 which implicitly indicates a Type 1 DMRS).

According to some embodiments of the present application, a legacy UE may receive multiple MsgA PUSCH resource configurations all of which are enhanced MsgA PUSCH resource configurations associated with an eType1 DMRS. In other words, the legacy UE is not configured with a MsgA PUSCH resource configuration associated with a Type 1 DMRS for transmitting a MsgA PUSCH transmission. Then, the legacy UE may stop 2-step random access procedure and switch to 4-step random access procedure. In some examples, the multiple MsgA PUSCH resource configurations may be configured for all uplink BWPs. In some other examples, the multiple MsgA PUSCH resource configurations may be configured for an active uplink BWP or configured for an initial uplink BWP.

As an example, in the case that there is no MsgA PUSCH resource configuration in Rel-16 (e.g., MsgA-PUSCH-Resource-r16) or enhanced MsgA PUSCH resource configuration associated with a Type 1 DMRS configured for all uplink BWPs, i.e., the MsgA PUSCH resource configurations for all uplink BWPs do not include a MsgA PUSCH resource configuration in Rel-16 or an enhanced MsgA PUSCH resource configuration associated with a Type 1 DMRS, the legacy UE may stop 2-step random access procedure and switch to 4-step random access procedure in which there is no transmission for MsgA PUSCH and corresponding DMRS.

As another example, in the case that there is no MsgA PUSCH resource configuration in Rel-16 (e.g., MsgA-PUSCH-Resource-r16) or enhanced MsgA PUSCH resource configuration associated with a Type 1 DMRS configured for an active uplink BWP (when the legacy UE is in an RRC connected state) or configured for an initial uplink BWP (when the legacy UE is in an RRC idle state or in an RRC inactive state), i.e., the MsgA PUSCH resource configurations for an active uplink BWP or for an initial uplink BWP do not include a MsgA PUSCH resource configuration in Rel-16 or an enhanced MsgA PUSCH resource configuration associated with a Type 1 DMRS, the legacy UE may stop 2-step random access procedure and switch to 4-step random access procedure in which there is no transmission for MsgA PUSCH and corresponding DMRS.

In some embodiments, the multiple MsgA PUSCH resource configurations configured by the BS (e.g., the multiple MsgA PUSCH resource configurations received in operation 301) may include an enhanced MsgA PUSCH resource configuration (e.g., MsgA-PUSCH-Resource-r18) associated with an eType1 DMRS and another MsgA PUSCH resource configuration (e.g., MsgA-PUSCH-Resource-r18 or

MsgA-PUSCH-Resource-r16) associated with a Type 1 DMRS. In some cases, a time-frequency resource configured by the enhanced MsgA PUSCH resource configuration may overlaps with a time-frequency resource configured by the another MsgA PUSCH resource configuration, and thus there may be an interference between Type 1 DMRS and eType1 DMRS even with different DMRS port indexes on account of different OCC lengths. To solve the above problem, an enhanced MsgA DMRS configuration (e.g., MsgA-DMRS-Config-r18) in the enhanced MsgA PUSCH resource configuration and a MsgA DMRS configuration (e.g., MsgA-DMRS-Config-r18 or MsgA-DMRS-Config-r16) in the another MsgA PUSCH resource configuration may indicate different CDM groups for determining DMRS port(s).

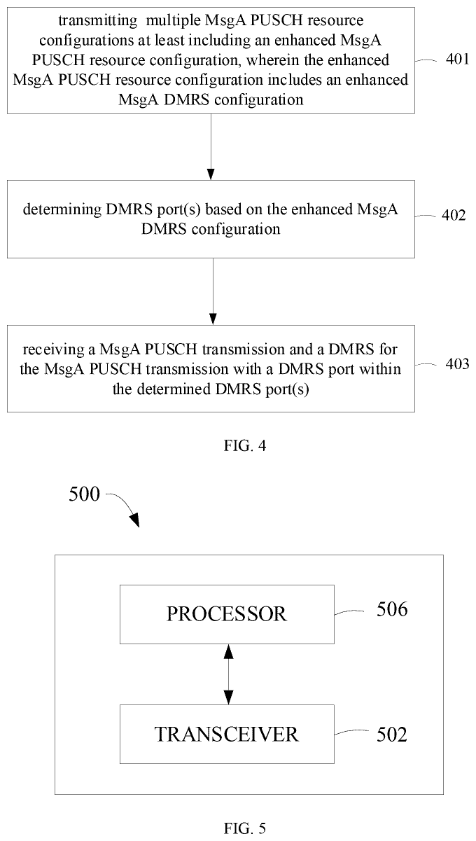

FIG. 4 is a flow chart illustrating an exemplary method for enhanced DMRS according to some other embodiments of the present application. The method illustrated in FIG. 4 may be implemented by a BS (e.g., BS 102 as shown in FIG. 1) or any other device having similar functions.

In the exemplary method shown in FIG. 4, in operation 401, the BS may transmit multiple MsgA PUSCH resource configurations to a UE (e.g., UE 101a or UE 101b as shown in FIG. 1). The multiple MsgA PUSCH resource configurations at least include an enhanced MsgA PUSCH resource configuration (e.g., MsgA-PUSCH-Resource-r18). The enhanced MsgA PUSCH resource configuration may include an enhanced MsgA DMRS configuration (e.g., MsgA-DMRS-Config-r18). All the definitions and designs related to the multiple MsgA PUSCH resource configurations, enhanced MsgA PUSCH resource configuration, and enhanced MsgA DMRS configuration as described with respect to the method illustrated in FIG. 3 may also apply here. Thus, details are omitted for simplicity.

In operation 402, the BS may determine DMRS port(s) based on the enhanced MsgA DMRS configuration. It is contemplated that the operations of the BS for determining DMRS port(s) may be similar to those of the UE which are described with respect to operation 302 in FIG. 3. Thus, details are omitted for simplicity.

After determining DMRS port(s), in operation 403, the BS may receive a MsgA PUSCH transmission and a DMRS for the MsgA PUSCH transmission with a DMRS port within the determined DMRS port(s). For example, the BS may receive a MsgA preamble in an RO, wherein the MsgA preamble is from a group of preambles associated with the determined DMRS port(s). The MsgA preamble in an RO may be associated with a PO and a DMRS port within the determined DMRS port(s). Then, the BS may receive a MsgA PUSCH transmission and a DMRS for the MsgA PUSCH transmission in the PO with the DMRS port associated with the MsgA preamble in the RO.

FIG. 5 illustrates a simplified block diagram of an exemplary apparatus 500 for enhanced DMRS according to some embodiments of the present application. In some embodiments, the apparatus 500 may be or include at least part of a UE (e.g., UE 101a or UE 101b in FIG. 1). In some other embodiments, the apparatus 500 may be or include at least part of a BS (e.g., BS 102 in FIG. 1).

Referring to FIG. 5, the apparatus 500 may include at least one transceiver 502 and at least one processor 506. The at least one transceiver 502 is coupled to the at least one processor 506.

Although in this figure, elements such as the transceiver 502 and the processor 506 are illustrated in the singular, the plural is contemplated unless a limitation to the singular is explicitly stated. In some embodiments of the present application, the transceiver 502 may be divided into two devices, such as receiving circuitry (or a receiver) and transmitting circuitry (or a transmitter). In some embodiments of the present application, the apparatus 500 may further include an input device, a memory, and/or other components. The transceiver 502 and the processor 506 may be configured to perform any of the methods described herein (e.g., the methods described with respect to FIGS. 2-4 or other methods described in the embodiments of the present application).

According to some embodiments of the present application, the apparatus 500 may be a UE, and the transceiver 502 and the processor 506 may be configured to perform operations of a UE in any of the methods as described with respect to FIGS. 2 and 3 or other methods described in the embodiments of the present application. For example, the transceiver 502 may receive multiple MsgA PUSCH resource configurations at least including an enhanced MsgA PUSCH resource configuration, wherein the enhanced MsgA PUSCH resource configuration includes an enhanced MsgA DMRS configuration; the processor 506 may determine DMRS port(s) based on the enhanced MsgA DMRS configuration; and the transceiver 502 may further transmit a MsgA PUSCH transmission and a DMRS for the MsgA PUSCH transmission with a DMRS port selected from the determined DMRS port(s).

According to some embodiments of the present application, the apparatus 500 may be a BS, and the transceiver 502 and the processor 506 may be configured to perform operations of a BS in any of the methods as described with respect to FIGS. 2 and 4 or other methods described in the embodiments of the present application. For example, the transceiver 502 may transmit multiple MsgA PUSCH resource configurations at least including an enhanced MsgA PUSCH resource configuration, wherein the enhanced MsgA PUSCH resource configuration includes an enhanced MsgA DMRS configuration; the processor 506 may determine DMRS port(s) based on the enhanced MsgA DMRS configuration; and the transceiver 502 may further receive a MsgA PUSCH transmission and a DMRS for the MsgA PUSCH transmission with a DMRS port within the determined DMRS port(s).

In some embodiments of the present application, the apparatus 500 may further include at least one non-transitory computer-readable medium. In some embodiments of the present disclosure, the non-transitory computer-readable medium may have stored thereon computer-executable instructions to cause the processor 506 to implement any of the methods as described above. For example, the computer-executable instructions, when executed, may cause the processor 506 to interact with the transceiver 502, so as to perform operations of the methods, e.g., as described with respect to FIGS. 2-4 or other methods described in the embodiments of the present application.

The method according to any of the embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this application. For example, an embodiment of the present application provides an apparatus for enhanced DMRS, including a processor and a memory. Computer programmable instructions for implementing a method for enhanced DMRS are stored in the memory, and the processor is configured to perform the computer programmable instructions to implement the method for enhanced DMRS. The method for enhanced DMRS may be any method as described in the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method for enhanced DMRS according to any embodiment of the present application.

While this application has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the application by simply employing the elements of the independent claims. Accordingly, embodiments of the application as set forth herein are intended to be illustrative, not limiting. Various changes may be made without departing from the spirit and scope of the application.

In this disclosure, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

We claim:

1. A user equipment (UE), comprising:
a transceiver that:
receives multiple MsgA physical uplink shared channel (PUSCH) resource configurations at least including an enhanced MsgA PUSCH resource configuration, wherein the enhanced MsgA PUSCH resource configuration includes an enhanced MsgA demodulation reference signal (DMRS) configuration; and
a processor that is coupled with the transceiver and determines DMRS port(s) based on the enhanced MsgA DMRS configuration;
wherein the transceiver further transmits a MsgA PUSCH transmission and a DMRS for the MsgA PUSCH transmission with a DMRS port selected from the determined DMRS port(s).

2. The UE of claim 1, wherein the enhanced MsgA PUSCH resource configuration indicates a Type 1 DMRS or an enhanced Type 1 (eType1) DMRS.

3. The UE of claim 1, wherein the enhanced MsgA DMRS configuration indicates at least one of a first DMRS port group or a second DMRS port group from which the DMRS port(s) is (are) determined.

4. The UE of claim 3, wherein the first DMRS port group includes DMRS ports with indexes of 0 through 7 and the second DMRS port group includes DMRS ports with indexes of 8 through 15.

5. The UE of claim 3, wherein the enhanced MsgA DMRS configuration includes a parameter indicating a number of DMRS ports in each code division multiplexing (CDM) group of each DMRS port group for determining the DMRS port(s).

6. The UE of claim 5, wherein a value of the parameter indicates that the first DMRS port in each CDM group of each DMRS port group is used for determining the DMRS port(s).

7. The UE of claim 5, wherein a value of the parameter indicates that the first two DMRS ports in each CDM group of each DMRS port group are used for determining the DMRS port(s).

8. The UE of claim 5, wherein a value of the parameter indicates that four DMRS ports in each CDM group of each DMRS port group are used for determining the DMRS port(s).

9. The UE of claim 3, wherein in the case that the enhanced MsgA DMRS configuration does not include a parameter indicating a number of DMRS ports in each CDM group of each DMRS port group for determining the DMRS port(s), the processor determines that four DMRS ports in each CDM group of each DMRS port group are used for determining the DMRS port(s).

10. The UE of claim 1, wherein the enhanced MsgA DMRS configuration includes a parameter indicating a number of DMRS ports in each CDM group for determining the DMRS port(s), wherein a value of the parameter indicates that eight DMRS ports in each CDM group are used for determining the DMRS port(s).

11. The UE of claim 1, wherein in the case that the enhanced MsgA DMRS configuration does not include a parameter indicating a number of DMRS ports in each CDM group for determining the DMRS port(s), the processor determines the first four DMRS ports from each CDM group indicated in the enhanced MsgA DMRS configuration based on a parameter in the enhanced MsgA DMRS configuration indicating a single-symbol DMRS or a double-symbol DMRS.

12. The UE of claim 1, wherein the enhanced MsgA PUSCH resource configuration indicates that a number of resource blocks (RBs) or a number of interlaces in a PUSCH occasion is expected to be even.

13. The UE of claim 1, wherein in the case that the enhanced MsgA PUSCH resource configuration is associated with an eType1 DMRS and a time-frequency resource configured by the enhanced MsgA PUSCH resource configuration overlaps with a time-frequency resource configured by another MsgA PUSCH resource configuration associated with a Type 1 DMRS, the enhanced MsgA DMRS configuration and a MsgA DMRS configuration in the another MsgA PUSCH resource configuration indicate different CDM groups for determining DMRS port(s).

14. A base station (BS), comprising:
a transceiver that:
transmits multiple MsgA physical uplink shared channel (PUSCH) resource configurations at least including an enhanced MsgA PUSCH resource configuration, wherein the enhanced MsgA PUSCH resource configuration includes an enhanced MsgA demodulation reference signal (DMRS) configuration; and
a processor that is coupled with the transceiver and determines DMRS port(s) based on the enhanced MsgA DMRS configuration;
wherein the transceiver further receives a MsgA PUSCH transmission and a DMRS for the MsgA PUSCH transmission with a DMRS port within the determined DMRS port(s).

15. A method performed by a user equipment (UE), comprising:
receiving multiple MsgA physical uplink shared channel (PUSCH) resource configurations at least including an enhanced MsgA PUSCH resource configuration, wherein the enhanced MsgA PUSCH resource configuration includes an enhanced MsgA demodulation reference signal (DMRS) configuration;
determining DMRS port(s) based on the enhanced MsgA DMRS configuration; and
transmitting a MsgA PUSCH transmission and a DMRS for the MsgA PUSCH transmission with a DMRS port selected from the determined DMRS port(s).
